(19) United States
(12) Patent Application Publication
(10) Pub. No.: US 2006/0149681 A1
(43) Pub. Date: Jul. 6, 2006

(54) Method and system for the process of music creation, development, and distribution

(76) Inventor: Philip Hoyt Meisner, Hawthorne, NJ (US)

Correspondence Address: WHITE-WELKER & WELKER, LLC, P.O. BOX 199, CLEAR SPRING, MD, 21722-0199, US

(21) Appl. No.: 11/292,897

(22) Filed: Dec. 3, 2005

Related U.S. Application Data
(60) Provisional application No. 60/633,108, filed on Dec. 4, 2004.

(51) Int. Cl. G06Q 99/00

(52) U.S. Cl. 705/52

(57) ABSTRACT

The present invention represents accomplishes the basic idea of providing a marketplace platform through which music and consumer purchasing power can be directly exchanged. It is a downloadable application wherein music files are stored on a central system, not a P2P network of linked computers. The present invention merges a basic platform structure with an Internet retail website. A new and used listing function that allows independent and non-major label represented artists to upload and list their music on the service for any price that the musician/artist desires. Users can then search for and purchase this music with a small fee going to the provider and the balance to the independent musician/artist. Independent artists may also choose to promote their music in addition to a standard listing by selecting any number of listing enhancements including but not exclusive to featured spaces on the application front page, first priority in the user search. The independent music list/buy/sell system is accompanied by an online music store system for major label represented artist, as well, but which functions under a different sales/revenue principle. Here a user can search for and download music files from these major music label represented artists at a price that is a function of the content agreement signed with the major record label.

### CROSS REFERENCE TO RELATED APPLICATIONS

This application claims priority from U.S. Provisional Patent Application Ser. No. 60/633,108, entitled “Method and System for The Process of Music Creation, Development, and Distribution”, filed on Dec. 4, 2004.

### FEDERALLY SPONSORED RESEARCH

Not Applicable

### SEQUENCE LISTING OR PROGRAM

Not Applicable

### TECHNICAL FIELD OF THE INVENTION

The present invention relates generally to media distribution. More specifically the present invention relates to the process of music creation, development, and distribution from the initial step of recording the musical performance to the final step of mass distribution and consumption.

### BACKGROUND OF THE INVENTION

The present process of music creation, development, and distribution from the initial step of recording the musical performance to the final step of mass distribution and consumption is disjointed. Currently, normal consumer market dynamics are interrupted and the consumer's choice is vastly limited by the presence of a pre-selecting authority, the music industry, that first weeds the bulk of music out and then packages and promotes only a small amount of that music for distribution to the general public.

The current perception in the music industry is that music is equivalent to writing in that it is made in such abundance that a selecting authority/industry is necessary in order to extract the best for presentation to the general public for consumption. Continuing with this premise, the production and distribution costs of music (recording, packaging, advertising, etc.) are high and ultimately must be shouldered by the consumer. It is only possible to produce and distribute that which the mass market of consumers will buy. The presence of the selecting authority/industry is seemingly necessary because there is too vast an amount of music to be produced and then distributed to mass-market consumers for their selection. The selecting authority therefore interrupts the natural course of market competition and consumer selection that yields the best product to the consumer.

Currently there is a pre-selection made for the consumer. Market competition and consumer choice occur only after this pre-selection within a false marketplace not nearly representative of a much larger pool of music. The competition and selection occurs only within this sample pool and yields only the result of the best music from this pool to become popular, not the best music from the greater pool that contains the vast majority of music. There are six major music labels along with of scores their wholly owned subsidiary labels. Taken together this group represents the music/recording industry as far as the recording, mass production and mass distribution is concerned.

The present situation also does a great disservice to the seemingly obvious beneficiary of the structure, the music selecting authority/industry. It confines the industry as a pre-selecting authority to take large risks in making a selection from amongst the large pool of music to present to the consumer. It must assume all of the cost of bringing this music to the consumer. If consumers in the aggregate reject the music the industry selects for the pre-selected pool of music, then the industry must shoulder the related substantial loss. However, prior to the past four or five years, the benefits outweighed the costs associated with bringing these selections to market. This made the risk of an occasional consumer-rejected industry pre-selection worth shouldering on the part of the music industry. However, with the advent of Peer-to-Peer (P2P) file sharing and piracy, activities enabled by the emergence of new types of digital media and transference technology, this cost benefit structure has changed substantially. (P2P is a type of network in which each workstation has equivalent capabilities and responsibilities. This differs from client/server architectures, in which some computers are dedicated to serving the others.) Consequently, the music industry sales, revenue and resultant profit margins have been impacted significantly.

The implications of this decline in profit/revenue outlook and combined with the traditional risks of selecting music has produced severe ramifications. The music industry has attempted several alternatives. Instead of selecting from the general pool of music, a less predictable and now less profitable alternative, the industry has undertaken the “growing” of many new bands/musicians/artists. Rather than making a selection from amongst the general pool of music for later presentation to the public the music industry has instead itself untaken the design and production of music from scratch. Musicians/Music Groups and their music are assembled artificially by first surveying the market within a particular genre (e.g. pop) seeing what it will bear and then tailoring a music group or solo musician along with music to be performed. This amalgamation is then packaged and distributed to the consumer. This alternative interrupts the consumer market choice and competition further by ignoring, at least to some extent at present, the general pool of music.

The music industry's composite of a musician/music group and the resultant music does not arise organically but is offered to the consumer as though it was selected from the general pool of music. Although there is nothing inherently wrong with this “growing” approach to producing and bringing music to market, each instance has the effect of limiting what is drawn from the general pool of music to be offered to consumers. Although this alternative has not completely replaced the traditional role of music industry as pre-selector of the general pool, its increasing use and lower risk when backset against the declining revenue/profit position of the past few year, makes it a noticeable trend.

The wholesale reconfiguration of the music world to eliminate the existence of a pre-selecting authority/industry at once is not possible and not even desirable for music in general. What is needed is an offering of an alternative to the consumer that would allow them direct access to the general pool of music as a supplement to the pre-selection offered by the music industry. This would be beneficial to the consumer, the natural market function and even the music industry as selecting authority. Direct access to the general music pool would give the consumer increased-choice in a virtually limitless supply of music both in type and quantity of music. The natural market function of competition and the best product/music arising would be improved because the better product/music would be rewarded by consumer selection. Additionally, the music industry's risk in pre-selecting would be greatly reduced because the consumer unleashed within the general pool would begin to make choices. Thus, the best products would gain popularity and the music industry could then select those products for offering on a larger scale through their existing mechanisms.

A desirable solution would be to give the consumer an alternative in the form of an enabling device. Primarily, this device would allow the consumer easy access to the greater pool of music but would also act as a mechanism that allows the greater pool music easy access to the consumer. It would be impossible to organize this entire pool centrally for a consumer offering, it is only by constructing a medium through which this exchange can easily occur that the consumer can be given access to the larger pool of music. In essence, the solution to the problem of opening the larger pool of music lies in giving the consumer and the larger pool easy unfettered access to one another.

What is needed to accomplish this solution is a self-sustaining platform through which the consumer and the larger pool of music can interact with one another. Classically, this would be termed a marketplace. A marketplace through which non-music industry selected/produced music could be offered by those who produced it to the consumer. The consumer would wander through the marketplace, or go to those areas of the marketplace which were of interest to him/her and select music, a recorded and regulated transaction would occur between the two and market dynamics would take over.

It has been largely impossible to develop the self-sustaining platform because the entire configuration of music today presupposes high production and distribution costs of music (recording, packaging, advertising, etc.). These costs necessitate a pre-selecting authority/industry. Prior to the advent of digital music files, high speed internet transfers and technology that has made available the means of production, packaging, distribution and even marketing/advertising available to even the smallest of musicians/artists, the necessity of the pre-selecting authority/industry structure and configuration of the music world was necessary. Now, for exactly these technological reasons and their ongoing and accelerating development, the chief barrier to such a marketplace has been removed. There can be a quick and easy exchange of music between geographically disparate parties.

It has been erroneously argued that the pre-selection of music is necessary because the consumer can only listen to a limited amount of music and could never choose from amongst the larger pool. However, the present state of computer technology also allows the use of computer programs to carve the larger music pool into fields of taste and genre that are customizable by the consumer and are small enough for consumption. Also, the consumer in general market theory terms likes unfettered choice even if this results in an unwieldy offering of products. Ultimately, the best will rise based on its inherent superior and attractiveness to the consumer.

What is needed for offering the consumer access to the general pool of music can best be accomplished by providing a marketplace platform through which the consumer purchasing power and non-music industry selected/produced music could be exchanged with ease. This marketplace platform could best be accomplished through a computer downloadable application. Once downloaded this application would readily interface with central servers via the Internet or other similar multi-user network. On these servers would be housed music files that were uploaded by independent artists along with descriptive and pricing information. Consumers could browse this online inventory through the application and then download and pay for the music they would like to purchase. The collected monies would be transmitted to the independent artists or if the music purchased was that of a Major Music Label Represented Artists (MMLRA) it would be transmitted to that source.

The service provided by the present invention is primarily geared toward independent music labels as well as all non-label represented artists (herein referred to as independent artists) to allow them to sell their music at prices they set in a nationwide, Internet marketplace. This is particularly beneficial to independent labels and non-label represented artists because of their limited resources and access to promotion and sales through existing Internet music stores like iTunes or Napster.

The six major record labels and their subsidiary labels are not susceptible to the problem of limited resources and promotion however they can realize some benefit from the service of the present invention as well. The benefits would come in many forms: listing their artists for sale at prices comparable to those on other online music store and benefiting from revenue realized; making the user realize the connection of their purchase going directly to the artist impacting the trend of illegal P2P file sharing; and access to detailed demographic research that the system of the present invention collects on every download of industry, independent and non label represented artists enabling major record labels to use the single best predictive tool, the market, to determine which artists/bands they might want employ in the future.

A user benefits as well in three main respects. First they can easily find music from independent label artists and non-label artists that would be difficult or impossible to find anywhere else. Second, they can track, communicate with and listen too bands in their local area. Third, they can be on the cutting edge of new music and have access to music and artists that they would otherwise have great difficulty finding.

### SUMMARY OF THE INVENTION

In accordance with the present invention a method for providing a marketplace platform through which music and consumer purchasing power can be directly exchanged is provided which overcomes the aforementioned problems of the prior art.

The present invention accomplishes the basic idea of providing a marketplace platform through which music and consumer purchasing power can be directly exchanged. It is a downloadable application (software program with interface to a central server system (101) via the internet) like iTunes or Napster. Music files such as MP3 are stored on a central system, not a P2P network of linked computers which is well known in the prior art. The present invention merges this basic platform structure with that of an Internet retailer such as Half.com, or Amazon.com. A new and used listing function that allows independent (non-major label represented) artists to upload and list their music on the service for any price that the musician/artist desires. Users can then search for and purchase this music with a small fee going to the provider and the balance to the independent musician/artist. Independent artists may also choose to promote their music in addition to a standard listing by selecting any number of listing enhancements including but not exclusive to featured spaces on the application front page and/or first priority in the user search.

The independent music list/buy/sell system is accompanied by an online music store system for major label represented artist, as well, but which functions under a different sales/revenue principle. Here a user can search for and download music files from these major music label represented artists (MMLRA) at a price that is a function of the content agreement signed with the major record label. Like with other legitimate online music stores, not P2P file share networks, and download services the music content is sold to the service by the major record label under a content agreement as opposed to being sold by the artist themselves.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the setup steps of the present invention;

FIG. 2 illustrates the purchase sequence of the present invention;

FIG. 3 illustrates a sample user front page of the present invention;

FIG. 4 is diagram illustrating the functions map involved for artists, from signup to music upload and sale to fund dispersal;

FIGS. 5a-d illustrate the artist account creation wizard of the present invention;

FIGS. 6a-m illustrate various features of the artist account of the present invention;

FIG. 7 illustrate the artist resource features of the present invention;

FIGS. 8a-e illustrate the sell music function of the present invention.

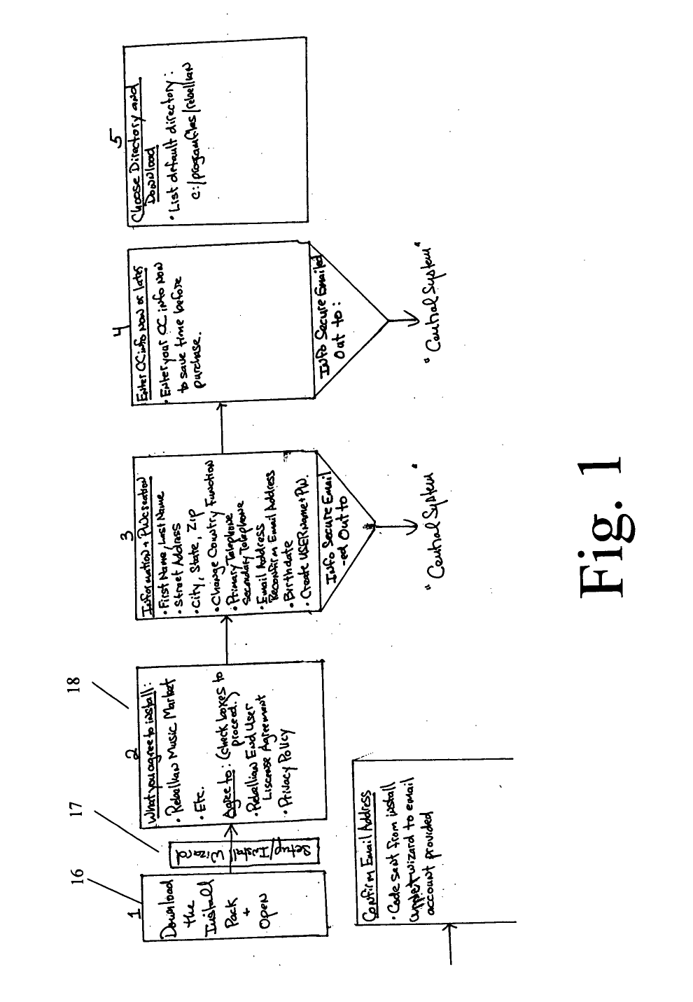

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the method and system of the present invention.

System Backend

The three main physical components of the system are: a central server system on which to store and serve the uploaded music files; an application to communicate with the central server system from the PCs and Macs of individual users; and content. Content provided by the major music label represented artists may or may not be stored and served through this system.

The system also handles all other aspects of the application that are subject to change and refreshing periodically. This would include the refreshing of any additional promotion features through a web dialogue between the application and the central server system. This aspect of the central server system would overlap with the central transaction processing system and database because when the purchase of an additional promotion is made it would be processed by the transaction processing database and then the actual promotion and its placement would be handled by the central server system.

A central transaction processing system and database through which all data necessary to complete a transaction between the artist and the user is stored and processed. When a user purchases a music file that is posted by an artist, either an Independent artists or a major music label represented artist, a contractual transaction takes place with the user promising to pay in consideration for the delivery of the music file.

The data necessary for completing this transaction is processed in this system. It includes: the user's USERID and account specifics; the artist's ARTISTID and account information; the date and time of purchase; the amount of purchase; the calculation of the provider fee; (vi.) the net amount to be paid to the artist which is determined by the original amount less the provider fee; and the name of the track and/or album purchased.

The central transaction processing system and database determines the adjustment to the accounts of the artists, the USER and provider. In a transaction between a user and artist it would determine the amount deducted from the user account, the amount added to the artist account and the amount added to the provider's account. The system would also keep a running total of all the accounts. The system would record all these calculations in a central database for reference purposes. This database would be displayed through the artist's sales dashboard and the user activity dashboard for those individuals reference. The central transaction processing system and database would also handle transactions for gift-certificate purchases and for paying forward into a users account in the same way as the transactions were handled above.

A central download statistical database that collects all information on each individual download including but not exclusive to: users who downloaded; user profiles (user profile includes—name, age, location, genre preferences, all past downloads); independent artist or major music label represented artist who uploaded song; the independent artist profile (Independent ARTISTS Profile includes—band name, principal member, genre, location/geographic home market, email address); and the transaction details such as the price paid for the download, the date and time of the transaction.

The central download statistical database's primary purpose is to collect all information on each individual sale of music, either a track or full album, regardless of whether it is from a listing by an Independent artist or by a major music label represented artist. This data can then be offered to major music labels for their use in scouting and signing independent artists more efficiently than their present method. This is accomplished by using the predictive tool of the market. A market is constructed between the user, as buyer, and independent artists who list their music on the service, as seller. Each individual transaction is recorded according to the method described above. The recorded data yields patterns among user purchases of music and gives an accurate prediction of an Independent artists success in general based on the amount of their music that is purchased and downloaded by users. The data also predicts success more specifically amongst certain user age groups (e.g. 18-25 demographic) or in certain geographic markets (e.g. Chicago or Montreal Metro Region) or in other geographic regions because of specific likes of that region (e.g. Punk Rock in Seattle or Southern Rock in London).

A major music label or its subsidiary could effectively use this information to add to its offering of produced music with a high degree of specificity. For example, the need for a country band popular amongst the twenty-five through thirty-five demographic in the Midwest and South of the United States arises. The major music label or subsidiary could use the central download statistical database's to find a band like this already popular amongst the provider's users and sign them.

The different demographic factors (date/time, genre, geographic markets, etc) can be mixed and matched by using the database to yield myriad predictive results, all of which are referenced back to the concrete transaction records. Some results might include: the sorting of the download statistics in the database by genre, date/time and region in order to track the increase or decrease in popularity of a particular genre in a particular region over a certain period of time; the sorting of the download statistics in the database by artist, geographic region and date/time, to track the rising popularity of a particular artist in a region during a certain period of time. E.g. the increase in popularity of a SKA band in the Pittsburgh Metro Area from May 2003 to the present; the sorting of the download statistics in the database by date/time and genre in order to track the rising popularity of a particular genre during a set period of time, system wide; the sorting of the download statistics in the database by date/time, artist and a number of different geographic markets in order to discover the rising or waning popularity of an artist outside his or her geographic home market; and there are numerous other combinations and the above serve as examples as to what statistical predictions could be made by manipulating the data in the database. The database and information is made available through a subscription service that allows graphical manipulation of the factors and is updated in real time.

Purchase Sequence

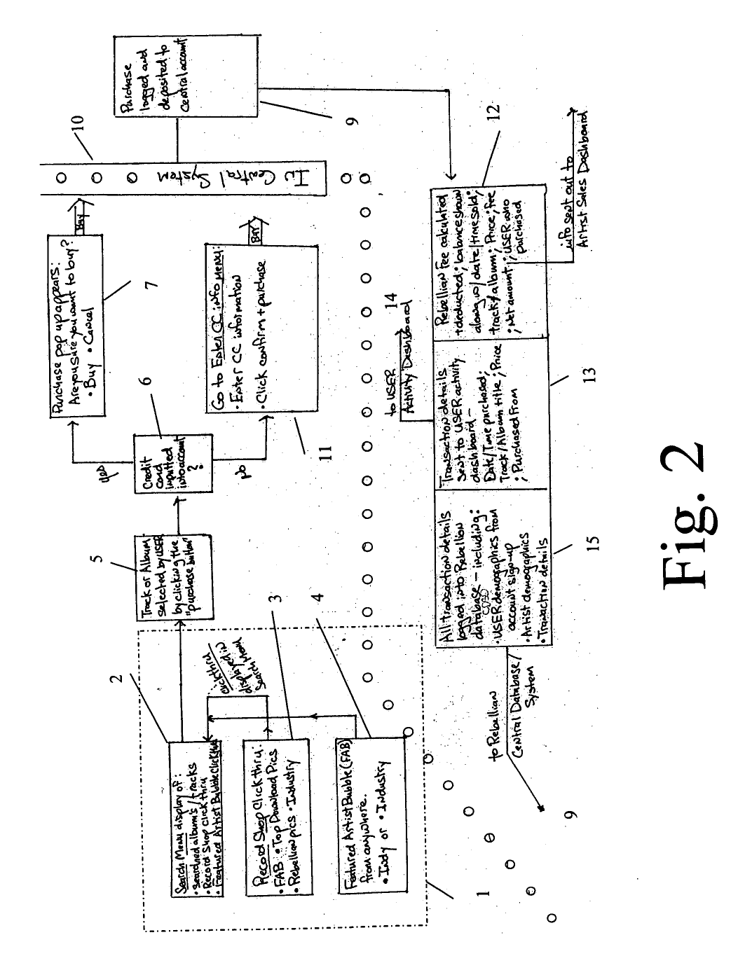

Now referring to FIG. 2, in a first step 1 the user selects a track, album or group of tracks or albums through a search menu display 2 of searched tracks or albums that were returned from a user initiated search or via a click thru from one of the avenues available on the user Front Page 3 such as the listing of the newly released independent artists, the listing of major music label represented artists music that has just been released, the listing of the daily top ten most downloaded songs, or the provider staff picks; featured artist bubble click thru 4 from the user front page or from anywhere else a featured artist bubble is displayed on the application.

In a second step 5 the user clicks on the purchase button that is attached to every track. If the user has inputted a Credit/Debit/Check Card into account 6, or has paid a balance forward then the purchase pop-up window 7 appears in the center of the application and has the question, “Are you sure you want to buy?” with the options of “Buy” and “Cancel”. If the user clicks “Buy” 8 then the purchase is logged in the central transaction processing system and database 9 and the transaction record is logged in the central download statistical database 10. From this point the transaction is logged in two different ways. If the user does not have a Credit/Debit/Check Card inputted into account 6, an enter Credit/Debit/Check Card Info pop-up window 11 appears in the center of the application with fields for all the pertinent information and the action button on the bottom saying “Confirm and Purchase”. There is also a box that can be checked that enables the user to link the Credit/Debit/Check Card entered with the account so that it in no longer necessary to enter it each time they make a music purchase.

First a transaction is logged into the central transaction processing system and database 9 where in step 12 the provider fee is calculated and deducted, the present artist balance is adjusted, the date and time of sale logged, the track/album logged, the price paid logged, the fee logged, the net amount logged and the user who purchased logged. This information is then sent in step 13 to the artist sales dashboard for display under the music management function. Conversely, the information is sent to the user activity dashboard 14 under the headings of date/time purchased, track/album title, price, artist purchased from.

Finally, all transaction details are logged 15 into the provider's central download statistical database 9 including all the transaction details as well as user demographics from account sign-up and artist demographics from account signup.

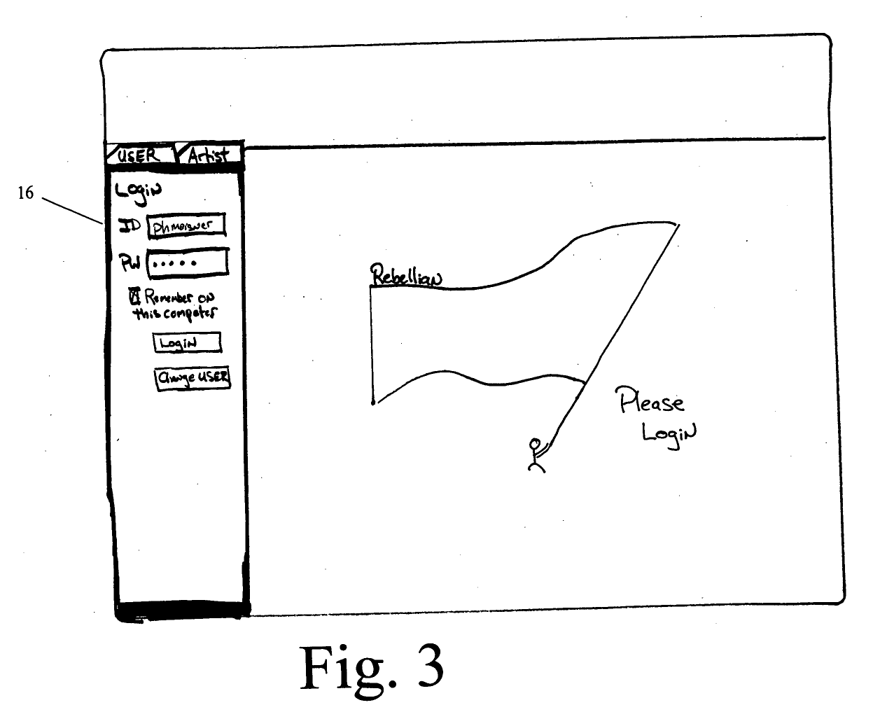

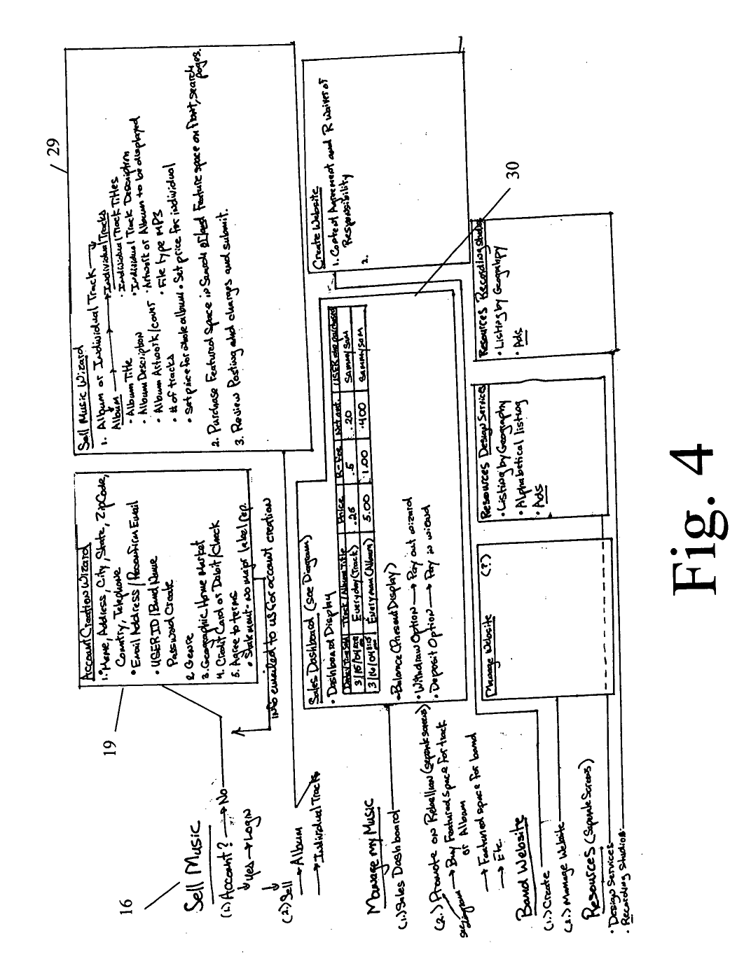

Now referring to FIG. 3, the user front page 16 is the first page that the user sees when opening the application either for the first time after a successful install or during a routine opening of the provider application. Its main purpose is to provide the user with a welcoming homepage from which to navigate and drill into the rest of the application. It also presents the user with a first taste of the music available on the system. Part of this is accomplished through additional promotion that the independent artist or major music label represented artists and their representative labels and/or promotional agencies can purchase. This is also accomplished through mechanisms that are not promotional, that is they do not require purchase by the artists but are rather driven by other factors. There is a display of music either albums or individual tracks that have just been posted by independent artists. There is a separate display of new music on the system from major music label represented artists as well as several selected bands from the provider management. There is also a display of the day's top downloads. All of these displays of bands/artists/tracks/albums can be clicked through to a full display of these music files and the artists that posted them that is displayed in the Search Page function.

The search function is the primary mechanism by which the user can find music either by independent artists or major music label represented artists. The search function is set up so as to offer the maximum possible flexibility in selecting search fields and factors given the complex variety of music from independent artist or major music label represented artists, in a variety of geographies, a variety of genres, etc. The search function allows the user to search through any single one of these fields or in multiple variations.

The user is initially always directed to the full search however they can limit their search to either major music label represented artists—called an “Industry” search for simplicity sake or an Independent artist search called an “Indy” search also for simplicity sake. Segmenting the searches into Industry, Indy and Full is a way of allowing the user the ability to seek from one pool of music on listed on R-concept or the other or both. Within these main search pools a user can then further search for music based on a variety of fields. In a Full search and “Indy” search, the user can search through the fields of Title, Artist, Album, Genre and/or Geography however in an “Industry” search the geography is inaccessible because of the generally national and non-regional nature of these artists.

When a user enters into one of the main search pools (“Indy”, “Industry” or Full Search) prior to the user entering any information into the search fields several featured artists bubbles appear. If the user enters into the full search pool, then a number of featured artists bubbles are displayed, half of which promote major music label represented artists and the other half promote independent artists. If the user enters into the Indy search pool, then a number of featured artists bubbles are displayed all of promote independent artists. If the user enters into the Industry search pool, then a number of featured artists bubbles are displayed all of which promote major music label represented artists.

The search result is displayed in a grid below the search field, which remains for the reference of the user. The entire result is placed under a “tab” that allows the user to engage in multiple searches and move between each of these searches with ease similar to the way a user might click between windows on a desktop. The search results are displayed in a grid and segmented into categories—Song Title, Artist, Album, Time, Relevance, File Type, Price and all have a purchase button attached to them. The categories can be sorted individually and allow user to sort Song Title, Artist, Album in alphabetical or reverse alphabetical order and allows user to sort Time, Relevance and Price categories in ascending or descending order. The Purchase Buttons remain attached to each individual song/track entry.

If the Independent artist or the major music labeled represented artists opts for the R-concept promotional device of album promotion in the search results (see explanation below) then when user searches for a Song, Artist, or Album in either a Full, “Indy” or “Industry” search the album will appear in a display at the top of the search result display within the tab for that particular search. The Album display will consist of a small thumbnail piece of artwork that the Independent artist or major music labeled represented artist will provide when designing their promotional options. It will allow the user to immediately view and then purchase the album displayed. If the user search is vague, i.e., yielding multiple different Independent artists and/or Major music label represented artists and their Song Titles and Albums, all of whom have some bearing to the search (e.g. Search=“Fly away”[Song Title]; multiple different Artists and Major music label represented artists returned) then the one with the highest relevance will have their Album Promotion displayed.

The user library function of the present invention is the mechanism by which the user stores and categorizes the music that s/he has purchased. The library display is reflective of a file folder on the user's computer in the provider program file folder. It is in that location that the actual music files (MP3s, WMAs, etc.) are stored. The Library function displays each of these files along with information on their individual characteristics. This includes: File Name; Artist; Type of Artist—Independent (Indy) or Industry; Genre; Length; Album; if Indy Artist—artist's home geographic market; last time played; and the user Rating Function.

The user rating function is accomplished within the user library function and the user search function. After downloading a music file from an independent artist or major music labeled represented artists, the user can rate the music file through the rating function within the user library. There is a column within the library display of user downloaded files that if the music file has been un-rated by the user has a button display that says “Rate It”. If the file has been rated by the user then the present rating is displayed in this space. If the user clicks on the present rating it will give him/her an option to change the rating.

This user Rating Function dialogues with the CSS sending the user's rating in the Library to the CSS. The CSS then compiles this data into an aggregate from every user that rated that particular file. This yields an Average user Rating that is then attached to the music file for all other users to see when it is presented in the Search Page/Function. The data is also sent to Central Download Statistical Database 9 en masse with each individual user rating (not only the aggregate average rating) sent to the Database. This is, of course, housed along with the general user profile so that a data track on each individual user opinion of a music file can be kept.

Now referring to FIG. 2, a sample procedure for users from signup to music purchase to bill payment is provided. In a first step a user goes to provider's website to download R-concept application. Then in a second step the user downloads the provider's application and installs it on his/her computer. In step the user goes through the user registration process. In step 19 the user is automatically entered into the application under the user tab. In step the user selects a track or album or group of tracks or albums through a Search Menu display of searched albums or tracks that were returned from a user initiated search and then clicks thru from one of the avenues available on the user front page such as: the listing of the newly released independent artists; the listing of major music label represented artists music that has just been released; the listing of the daily top ten most downloaded songs, or the provider's staff picks; featured artist bubble click thru from the user front page or from anywhere else a featured artist bubble is displayed on the application. In step the user clicks on the purchase button that is attached to every track. In step, if user has inputted a Credit/Debit/Check Card into account, or has paid a balance forward (i.e. has a positive balance in his/her R-concept account) then the purchase pop-up window appears in the center of the application and has the question, “Are you sure you want to buy?” with the options of “Buy” and “Cancel”. If the user clicks “Buy” then the Purchase is logged in the Central Transaction Processing System and Database and the transaction record is logged in the Central Download Statistical Database 9.

If user does not have a Credit/Debit/Check Card inputted into account, an enter Credit/Debit/Check Card Info pop-up window appears in the center of the application with fields for all the pertinent information and the action button on the bottom saying “Confirm and Purchase”. There is also a box that can be checked that enables the user to link the Credit/Debit/Check Card entered with the account so that it in no longer necessary to enter it each time they make a music purchase.

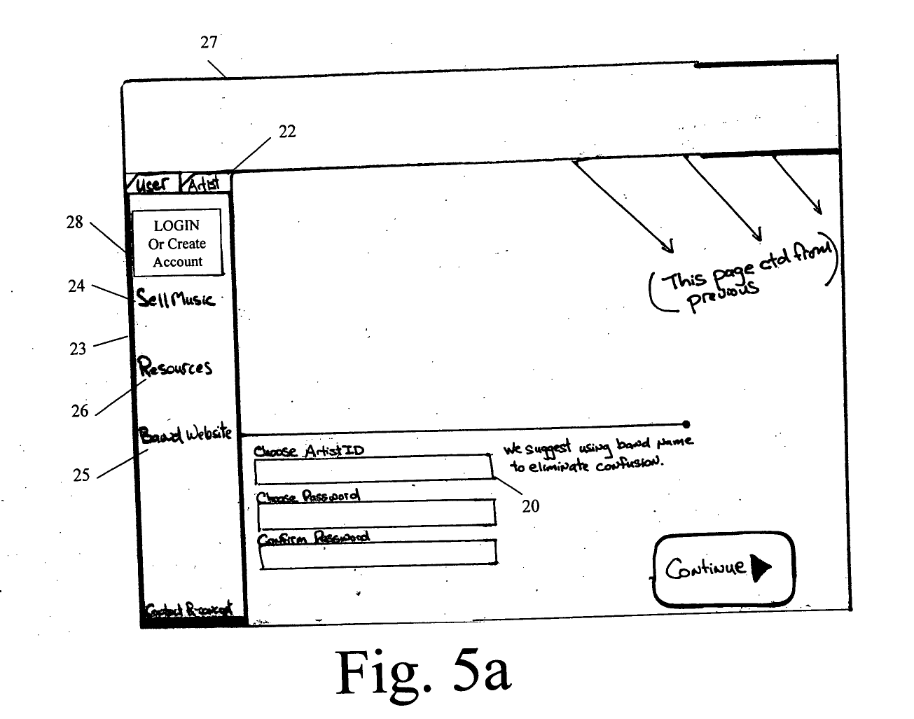

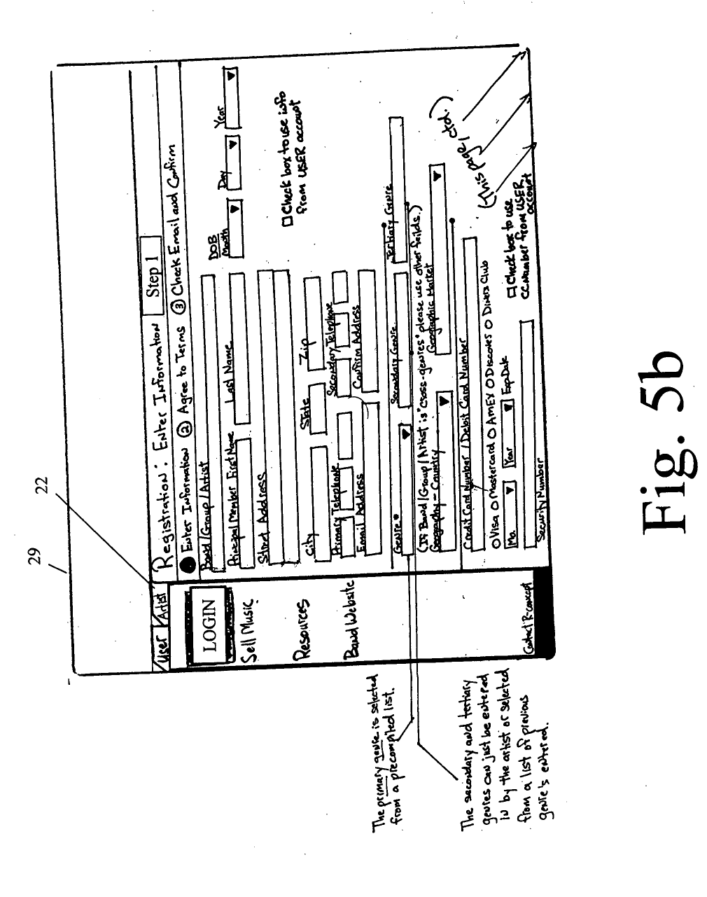

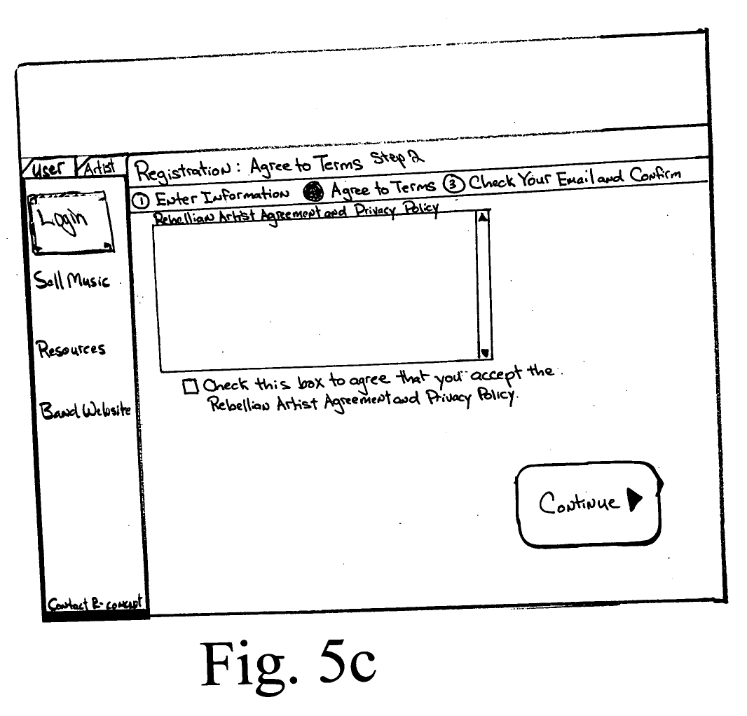

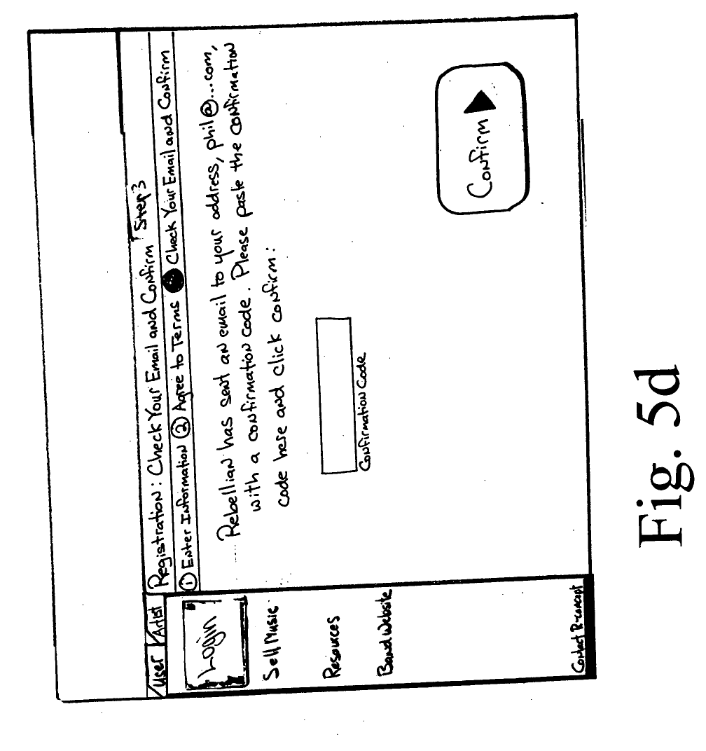

Now referring to FIG. 4, a sample procedure for artists from signup to music upload and sale to fund dispersal is provided. In a first step 17, an independent artists goes to a provider website to download the provider's application. In step 18, the independent artist downloads the provider's application and installs it on his/her computer. In step 19, the artist goes through the user registration process as illustrated in FIGS. 5a-d. Independent artists provide all information in step 19 to be registered as a user including providing a USERID that may be replicated as his/her ARTISTS ID 20. Next in Step 21, the independent artist goes to the artist tab 22 on the provider application and clicks it. The independent artist opens the artist tab by clicking and sees a two column page with a contents tab 23 on the left that contains various navigation options such as “Sell Music” 24, “Manage my Music”, “Band Website” 25, “Create Account”, and “Resources” 26. This page is called the artist front page.

Independent artist can choose any option in the contents tab 23. If s/he clicks on any option such as “Sell Music” 24, “Manage my Music”, “Band Website” 25, and “Resources” 26 he will be directed to the account login page 27. If s/he is not a registered artist she/he will be directed to a “Create Account” page. Also, she/he will have the “Create Account” option 28 available at the outset in the contents tab 23of the artist front page.

Independent artists chooses the “Create Account” option 28 and is directed to the “Create Account” wizard which asks him to provide: his true name (If a multi-member Band, then the true name of the principal member) Address, City, State, Zip Code, Country, Telephone; email address and a reconfirm of the email address; ARTISTID/band name and a password (if the artist wishes to have the same ARTISTID as the USERID she/he has created for his or her user account they may); the genre that they or their band is in; the geographic home market that they or their Band is in (there will be an extensive fixed list from which to choose); a Credit/Debit/Check Card and pertinent information such as billing address, expiration date, etc.; and an agreement to the terms of Use/an End User License agreement. All the information will be emailed to the provider's central transaction processing system and database and the central download statistical database 9 for account creation and processing of transactions. After step 19 the independent artist is returned to the artist front page where s/he has the same options available in the options tab, with the exception of the “Create Account” option, which has disappeared.

Now in Step 28, assume that independent artist chooses the option on the options tab of “Sell Music” 24, this would link thru to the sell music wizard 29. The independent artist would choose to sell an album or individual tracks. If the artist chooses an album he would be asked to provide the album title; album description; upload any album art or cover art for purposes of the album display; select the number of tracks (in the preferred embodiment a minimum of three tracks are required—this is referred to as a “demo album”, four to seven tracks are referred to as a “half album” and eight through an indefinite number are referred to as a “full album”); and set a price for the whole album. In Step 29, continuing under the sell album sequence the artist would then be directed to the individual tracks listing and upload page where they would enter the information on the individual tracks. The location on the independent artist's computer would be given and a “browse” function to find this location would be provided. The track information would include: the track title; the album it correlates to, if any; the run time; and the price. This information must be provided for each individual track.

In step 29, if the independent artist does not have a complete album or wants to sell tracks individually without an album designation, s/he may choose to list only tracks as an option in the sell music wizard. In this case, they would go directly to the individual tracks listing and upload page where they would enter the information on the individual tracks.

If music that the independent artist uploads is purchased by a user, then the monies the user pays are deposited into a central account and logged into the independent artist's dashboard display 30. The artist may view their present balance in this display. They may then click on the withdraw option if they so choose and be taken to the Withdraw Page. The Withdraw Page will allow them to choose the amount they wish to withdraw all or part of their present balance. They may choose to have the funds dispersed to them by check or sent to a third party account such as Paypal.

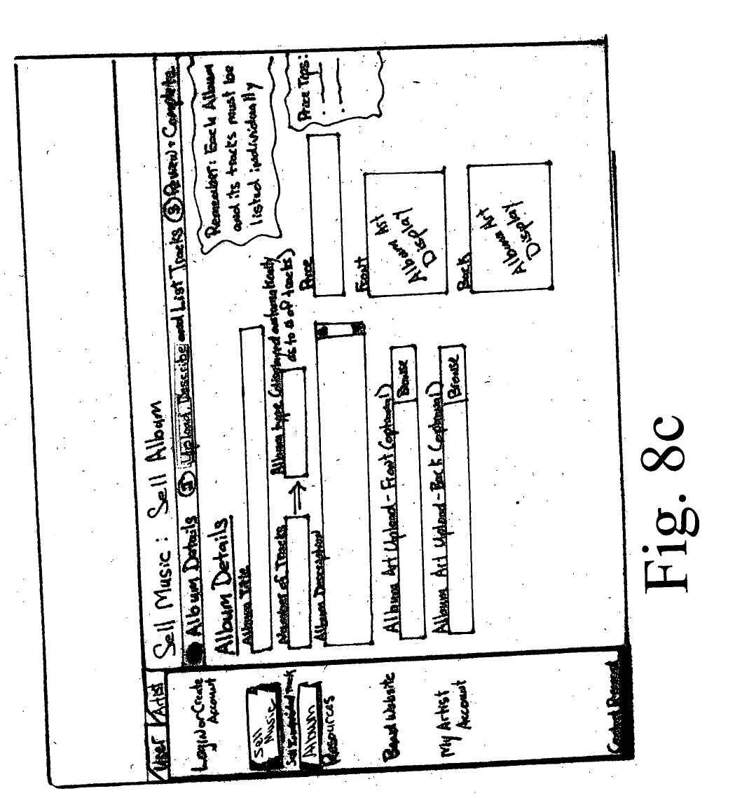

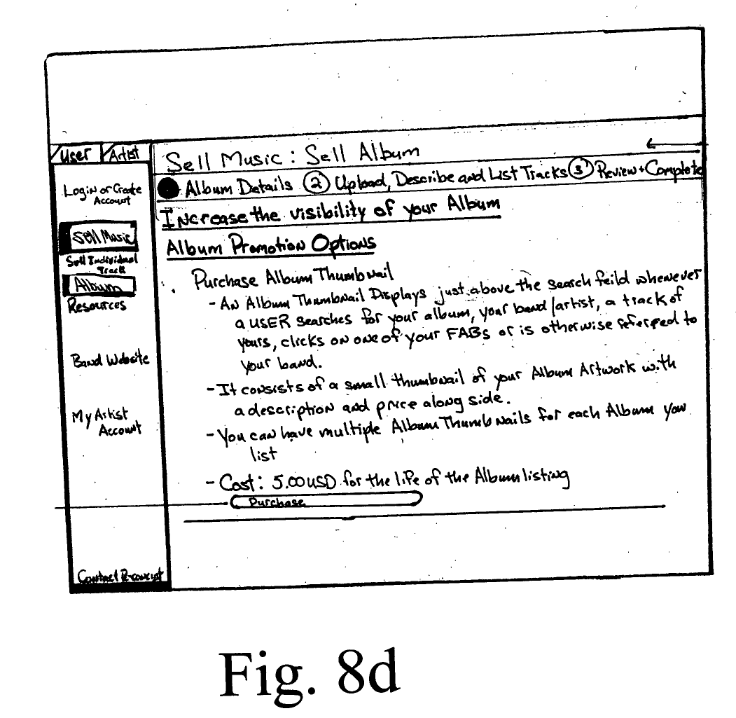

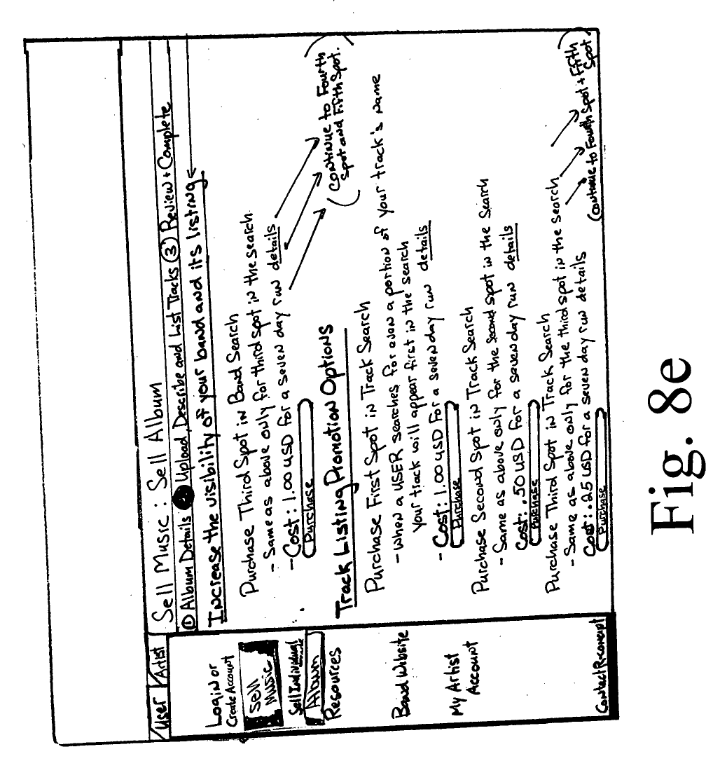

Now referring to FIGS. 8a-s the sell music function of the present invention is illustrated. In addition to listing their music on a provider's website for sale, independent artist can choose a variety of different promotion options that are offered through the system. These mechanisms are also available to major music label represented artists and their representative labels and/or promotional agencies. The major music label represented artists can use one of the below options as well as the independent artists. Although because they command superior resources compared to the independent artists they are prevented from buying all the available additional promotion devices and thereby boxing out an independent artist by being confined to a predetermined number of areas to be promoted. These promotion options primarily include the following but may be expanded in the future to include other methods of promotional offerings.

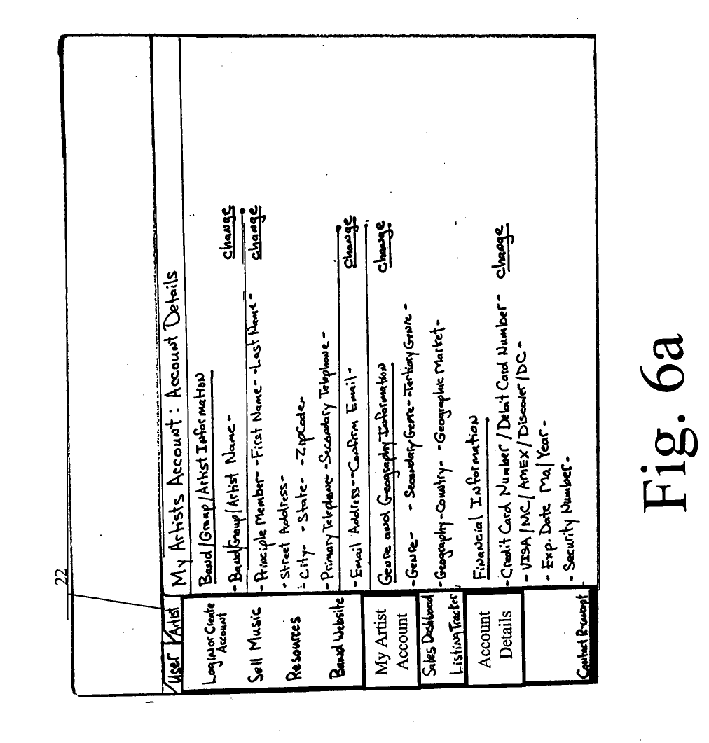

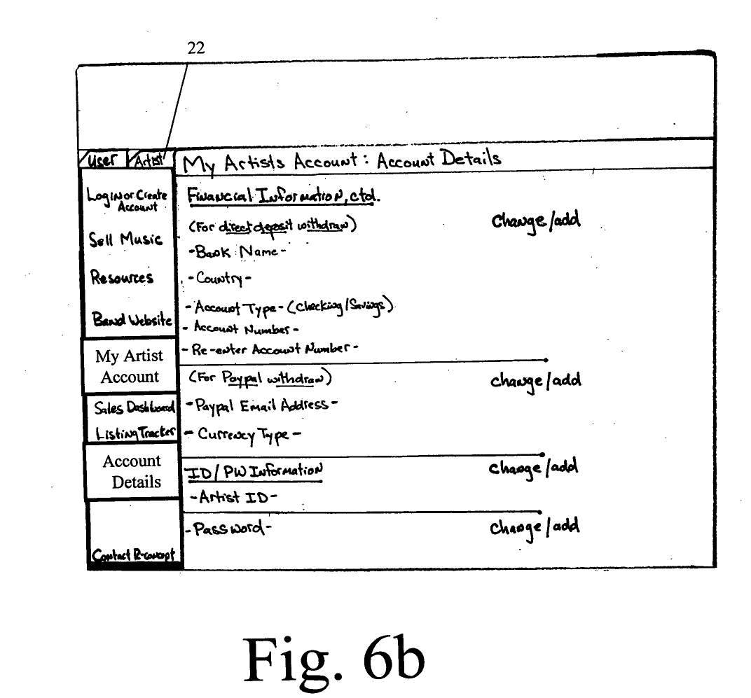

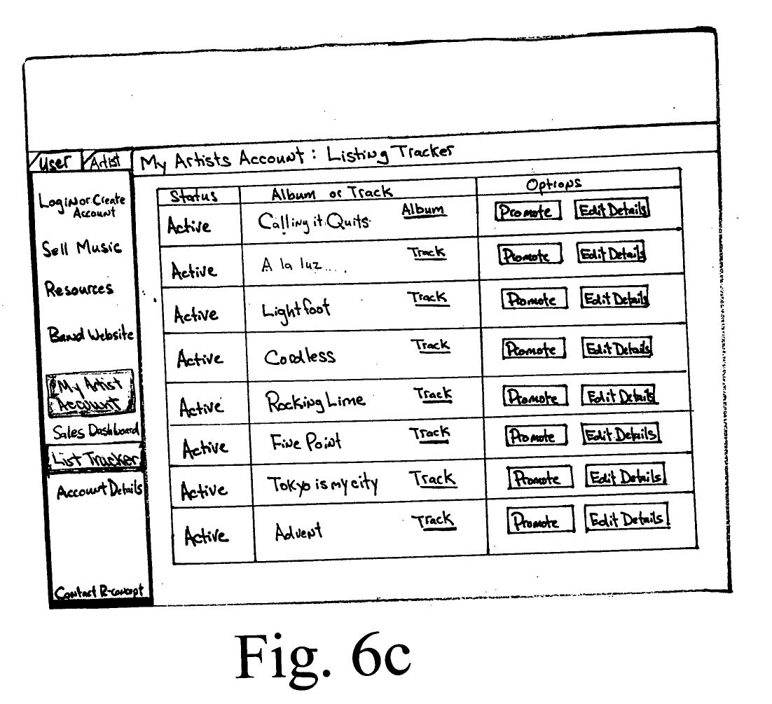

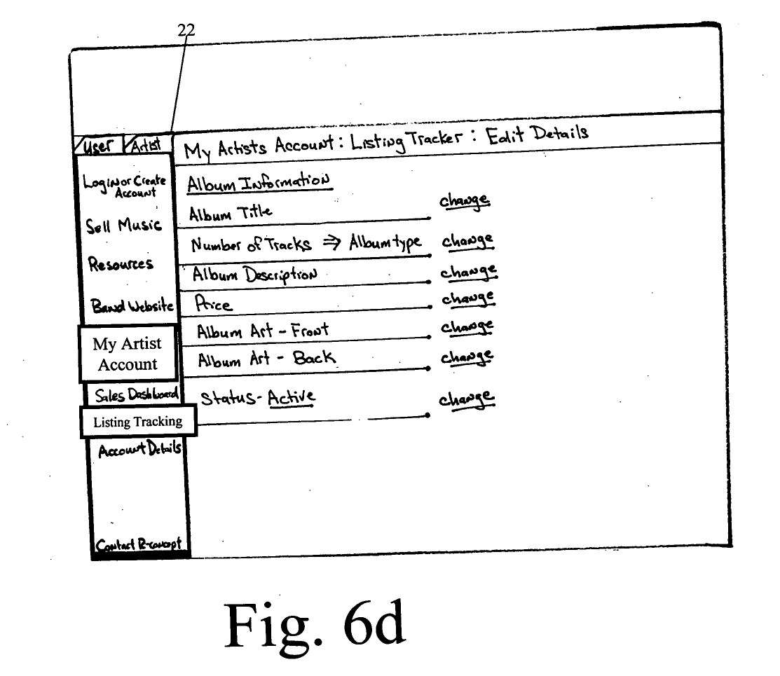

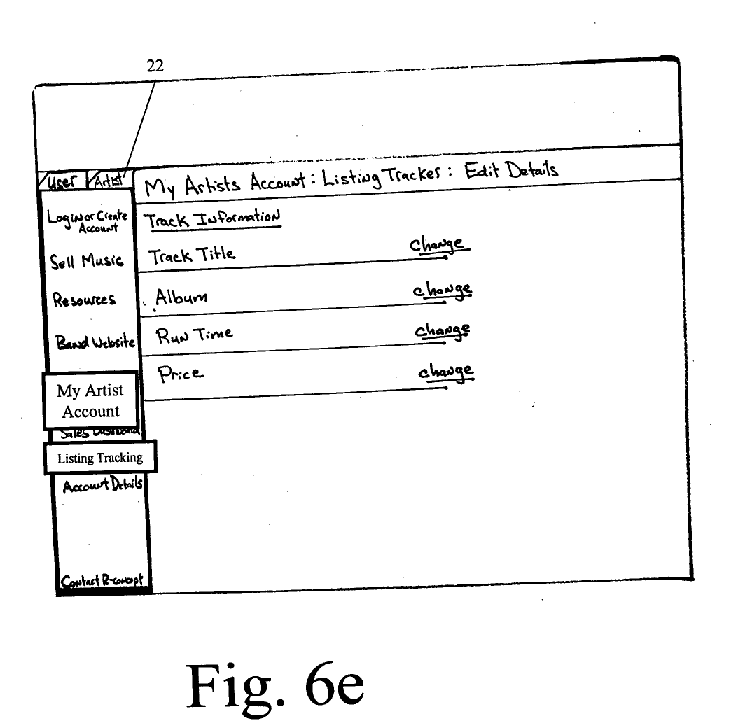

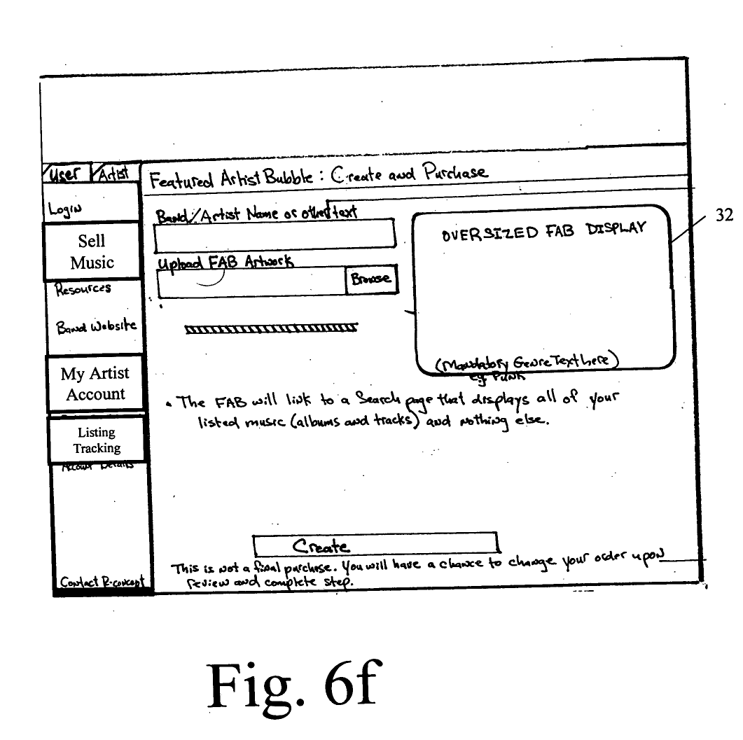

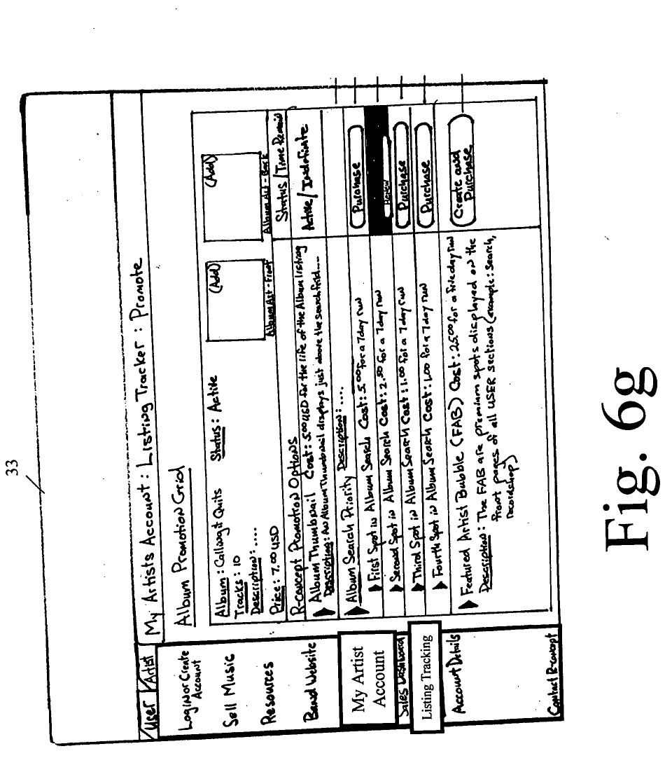

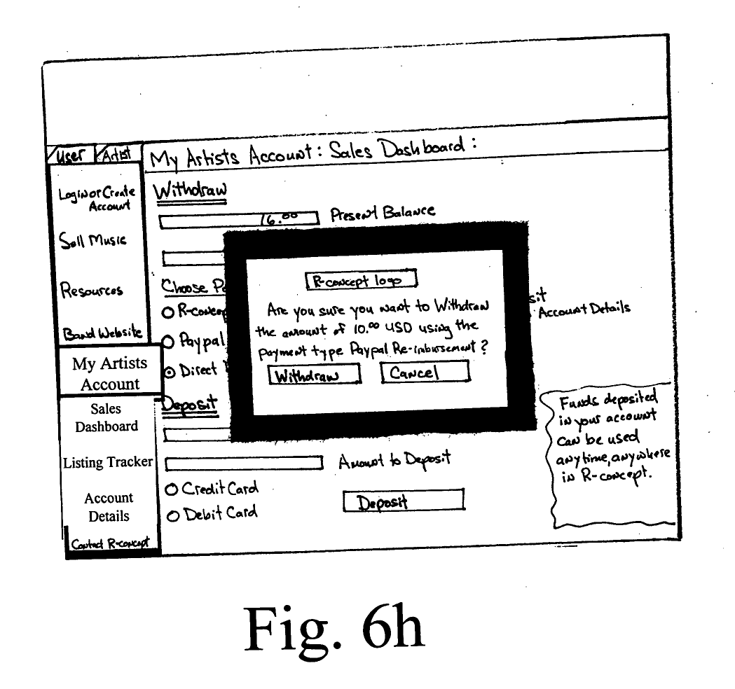

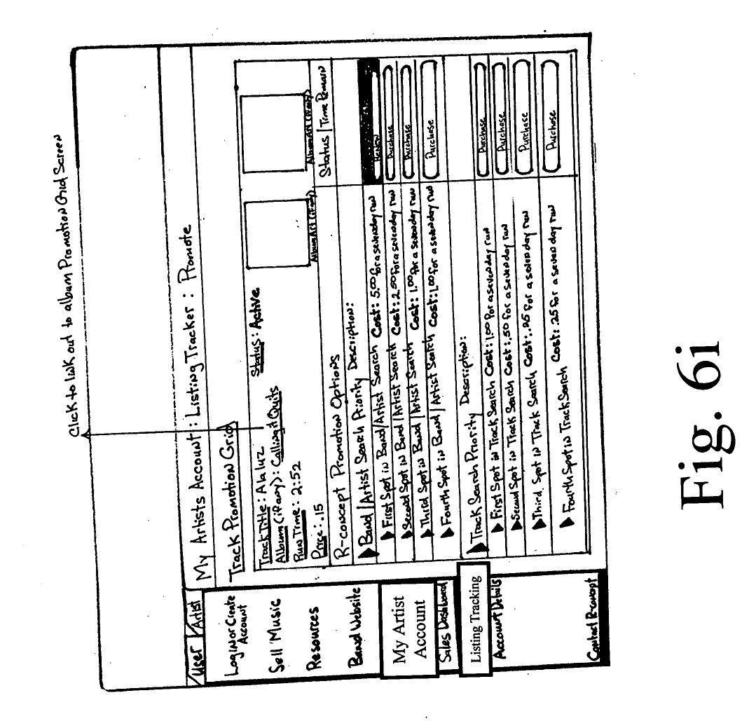

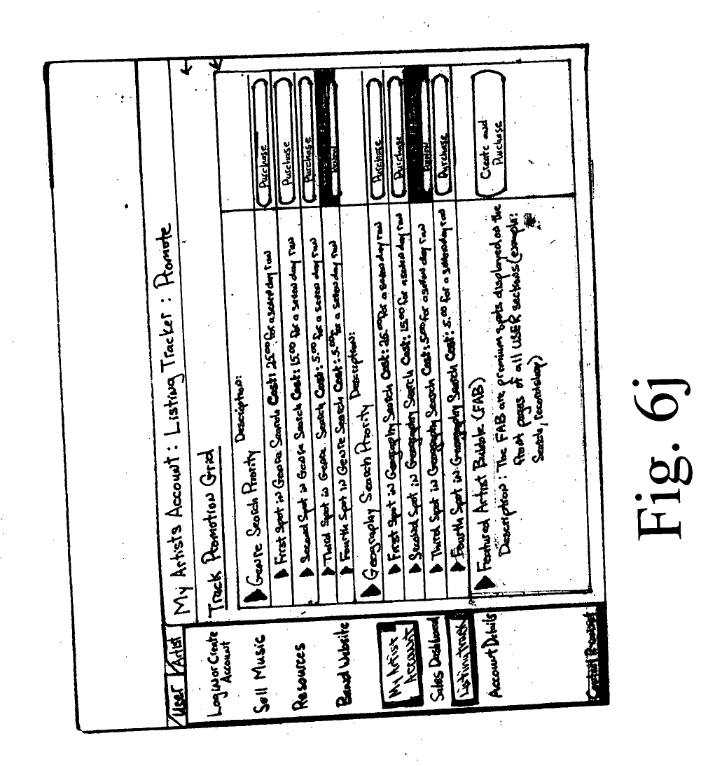

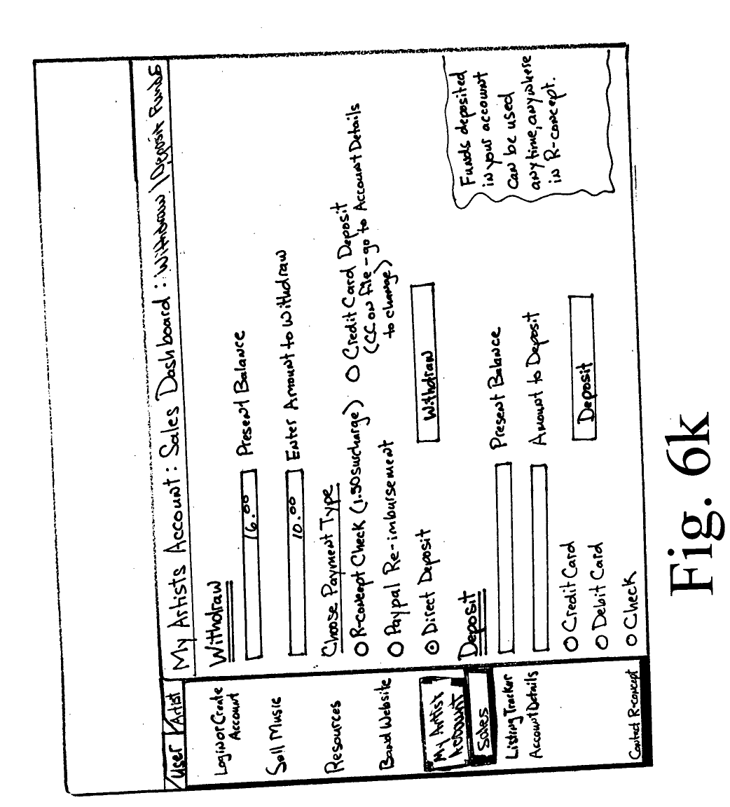

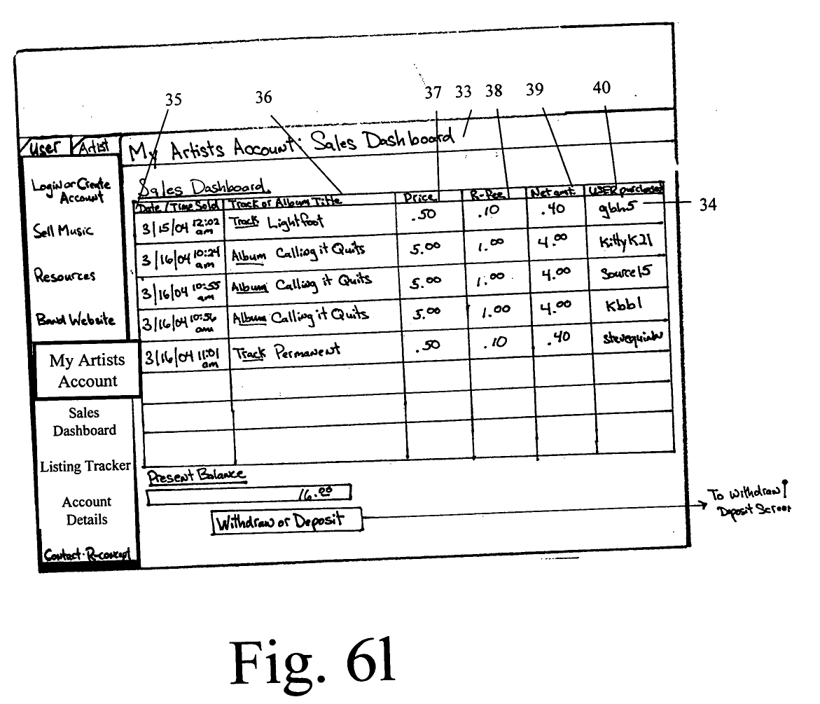

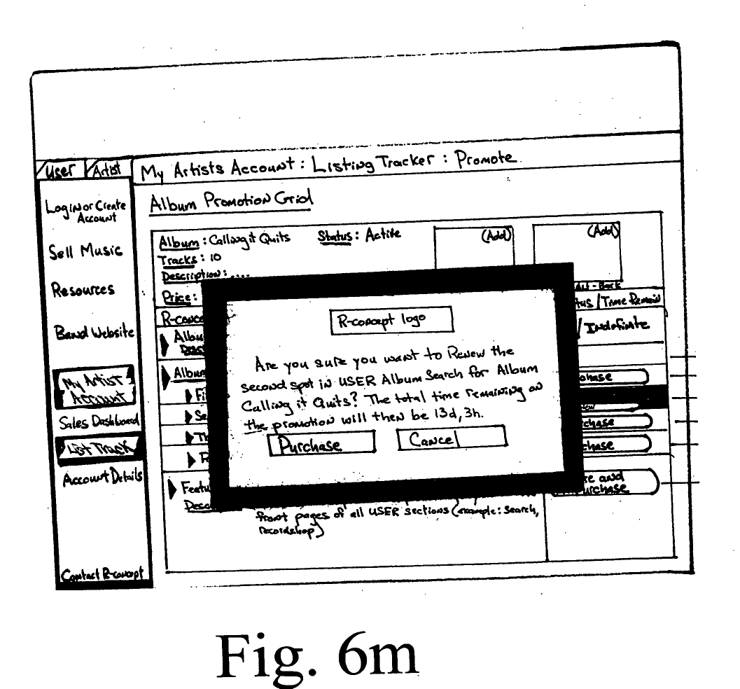

One promotional offering is the featured artist bubble 32 as shown in FIGS. 6 and 8, which allow an independent artist or major music label represented artists and their representative labels and/or promotional agencies to enhance the exposure of an artist to the provider's online community of artist. The featured artist bubble 32 resembles very closely a rotating billboard. The billboard itself is stationary but its contents are always rotating. While a featured artist bubble would always remain in place the artist that is displayed within it would change depending upon the specific time periods the artist purchased it for.

The provider's application would constantly dialogue with the CSS which would be the repository for all the featured artist bubble details such as the artwork and layout of the contents as well as the click-thru to Search page display of tracks and albums information, how long and where it is to be displayed. The featured artist bubble 32 would be placed in virtually every available area of the application. There would be placement on virtually all of the pages of the user interface including the user front page and search page.

The cost varies as to where the featured artist bubble is placed within the application. A featured artist bubble that would be displayed on the front page would cost more than one displayed in the user library function. As with a billboard or advertising the primary unit of cost would be time. A first amount would be charged for one day of placement, a second amount would be charged for one week of placement.

The Click-thru is the sequence of events that occur if a user would click on a featured artist bubble. The user after clicking on the featured artist bubble would be taken to the user search function page and the Artists entire offering of tracks and albums would be displayed there as though the user had made an exclusive search of just that particular artist and had been given no other search results besides that artists offering. From that point the user could choose to purchase, listen to sample tracks that the artist offers, or move to another area.

Featured artist bubble 32 creation would occur in a separate window as shown in FIG. 6. Purchase and creation of a featured artist bubbles would be offered as an option under the additional promotion function under the artists interface. It would also be offered to the artists upon their listing any of their tracks or albums. Artists would be required to put their band name in plus artwork as a backing. Artwork could be uploaded or selected from a precompiled listing of clipart. Fonts for the band name could be uploaded or selected from a precompiled list. There would be a mandatory display in small white text along the bottom of the featured artist bubble to indicate the genre of the artist. This is done so as to give users some direction as to what type of artist they are clicking on.

An Artist's music that is listed on the provider's application is of course searchable by the user through the user search function. A search may return numerous results from many different artists. An independent artist or an major music label represented artist may therefore purchase a priority in the search result for any particular search term or category.

The overriding theme of the search priority purchase system 33 is to allow the Artists the maximum flexibility as to what terms they can purchase and how they can link them to the Tracks and Album that they are promoting as well as their own (Artist/Band/Musician's name) promotion. This engine resembles the way Google uses guided searching and the sale of specific search terms to vendors that is know in the prior art, but has several key variances that are necessary in order to graft it into the provider model.

Artists may purchase priority in any of the search fields provided: Title, Artist, Album, Genre for any term they wish. In the case of Geography, a search field in the “Indy” search pool alone, an Independent artist could purchase priority there as well. Some examples follow. They would likely choose the title of the track they are selling as a term for purchasing priority under the Title. They would likely choose the name of their band o [symbol] their name as a term for purchasing priority under the Artist. They would likely choose the name of their album or one of their albums as a term for purchasing priority under the Album. In purchasing priority for the Genre field they would pick not any term but the genre to which they were a part of from a set list. So any time a user search simply based on a specific Genre and no other search field that artist would appear first in the search. Geography would function much the same way as Genre except priority in this field would only be available to independent artists. An Artist could purchase priority in a Geography search by simply choosing their Geographic home market.

Priority for a particular search term would mean that when that specific term is searched by the user the search result would show the priority return first, second, third, fourth or fifth from the top of the search result page depending upon the priority position purchased by the Artist.

Priority terms need not confine themselves specifically to the Title of an Artist's track or the name of the Artists Album. The Artist can purchase priority for any search term they like for any of their Albums or Tracks that are for sale. For example, if the Artist has a track for sale entitled “Wind beneath my wings” they can purchase priority for the search term “Wind” or “Wings” in the any of the search fields (Title, Album, Artist, etc) although they would likely purchase these terms in the Title Search Field. The artist could also purchase multiple terms for a single Track or Album, increasing its exposure through a search.

An Artist is not confined to purchasing a term because it bears some textual relationship to his/her Track or Album Title or his/her Name. An artist is completely at liberty to purchase any search terms s/he may like and link it to any Track or Album or his or her own name. For example, if the artist wanted to purchase the search term “Greatest Rock Hits” and link that to an Album s/he is offering so that when the user searches “Greatest Rock Hits” that Album is returned in priority that would be possible.

Because genre and geography search fields are closed end in that they are chosen by the user form a given list as opposed to being open end where the user could enter any text they want, the purchase priority in a search term is less complex. The artist would simply choose the Genre or Geography they are in and purchase priority for that search term/category.

In order for an Artists priority spot to be returned in a user search the user would have to enter the precise term, though not case specifically, and not any variation. It would also have to be entered into the correct search field of Title, Artist, Album, Genre or Geography.

The cost would vary depending upon the popularity of the search term that the Artist wished to purchase. The Artist could purchase the Search term for a specific number of searches or for a set period of time. The Priority spaces of first, second, third, fourth, fifth form the top of the search result would also slide as to price with first being the most costly and fifth being the least.

The remainder of Search returns below the priority would come in as normal and the USER could still sort the Search Result by any category (Title, Indy/Industry, Length, Search Relevance, etc.) and disperse the priority returns amongst the regular returns as a result of this Search.

The purpose of Album promotion would be to offer a means to the Artist to promote a specific album either when the user searches for one of the Artist's individual tracks, when user clicks thru a featured artists bubbles, or when a user otherwise searches for a band. If the user search is vague, i.e., yielding multiple different Independent artists and/or Major music label represented artists and their Song Titles and Albums, all of whom have some bearing to the search (e.g. Search=“Fly away”[Song Title]; multiple different Artists and Major music label represented artists returned) then the one with the highest relevance will have their Album Promotion displayed. Album Promotion can also be used in conjunction with the Search Priority Purchase System. The Album promotion could be used either by an Independent artist or by a major music label represented artist or their representative label or promotion company. If an artist lists an album for sale it would be likely that they would opt for the Album promotion because it creates a visual presence and identity through a virtual packaging for the Album. Without this packaging the Album is essentially a package of Tracks to the user.

Album promotion consists of a small thumbnail picture of artwork that is provided by the Artist or selected form a group of clipart. It is positioned in the user search page function just above the search result.

Function and user click thru functions very similarly to a featured artist bubble except when it is clicked by the user it sends the user to a search page result that is devoted solely to that Album. This includes just the Album artwork that is slightly enlarged from its thumbnail size and a Search Result of just the Tracks that are on that Album. The Tracks can be purchased individually or the Album can be purchased entirely. There is a purchase button positioned next to the slightly enlarged Album artwork as well as a brief description of the Album and a link to further information that the Artist could provide.

All additional promotion would be offered to the artists during their initial listing of music (in the case of artist) or they could choose to upgrade their listings or band/artist promotion after the listing by going through the Manage My Music function where the Additional Promotion options would be available.

The purpose of the Sales Dashboard 33 is to allow the Independent artist to monitor all the transaction made that involve the purchase of the music that s/he has listed. This information is displayed in a grid 34 and consists of: the date and time sold 35; the track or album title 36; the price 37; the provider fee 38; the net amount they received 39; and the user who purchased 40 as illustrated in FIG. 6.

The Sales Dashboard page as a whole also offers other options such as the Withdraw Option 34—that allows the Independent artist to withdraw 41 the funds s/he has accrued from the sale of music. Also the Deposit Option 42 that allows the Independent artist to put funds into their account by way of credit/debit/check card. This money could be used for the purpose of buying additional promotion or other items.

The Resource Directory 43 illustrated in FIG. 6 provides the Independent artist with a listing of various services that function independently of the provider but may be helpful to the Independent artist. There may be several classifications of services added to this area of the application. Initially, there would be a design directory that would be a listing of several creative designers that can assist the Independent artist in developing image designs, artwork for album covers, etc. Also, a listing of recording studios sorted by geographic location for use by the Independent artist would be provided for their use. In addition, there would likely be a listing and review of home music production software.

There would be a section also devoted to specific provider paraphernalia such as bumper stickers, palm cards, lighters, etc. that promote the Independent artist's listings of music. For example, a bumper sticker that says “Buy our music at R-Concept” and other such promotional tools would be provided. Cost would vary—some of these promotional devices would be free and others would involve a cost to the Independent artist. The businesses that provide these services and products may be charged for the listing if necessary.

The provider store for users and Independent artists will offer a few items to begin with. Among them are apparel, online gift certificates and “provider-cash”. (“Provider-cash” is a means for an individual to pay an account balance forward, for example putting $20.00 into an account, without the user having access to the Credit/Debit/Check Card. This is ideal for a parent child situation where the parent can give the child a certain amount of money to spend on R-Concept but not give him/her access to the Credit/Debit/Check Card number.)

The contact provider option is available to both the user and the artists and can be seen at all times on the application. The click-thru of the contact option will lead to a page that displays various email addresses and contact information as well as links back to the corporate page.

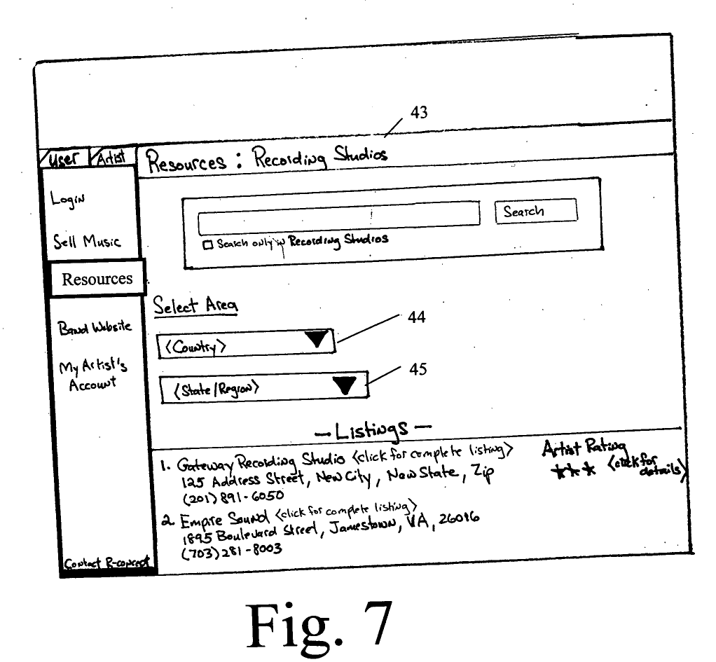

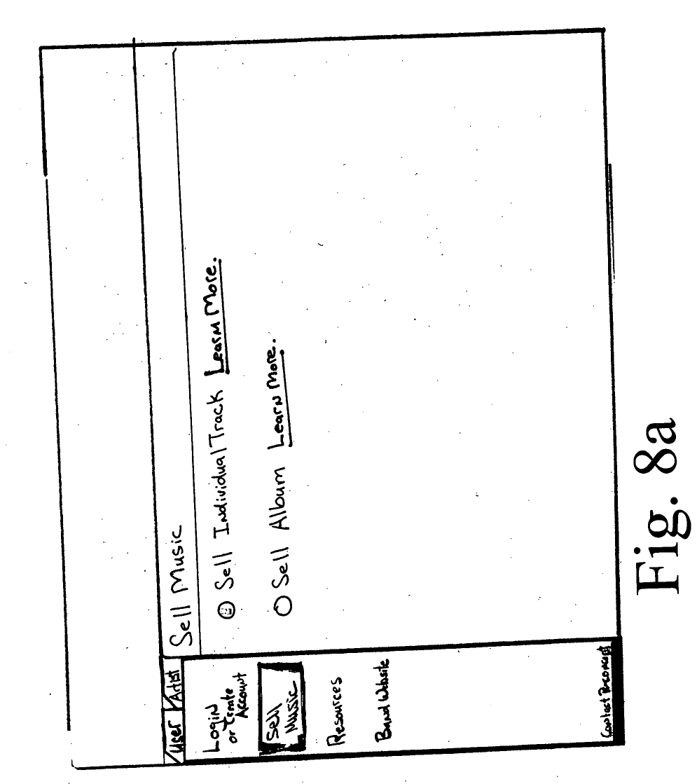

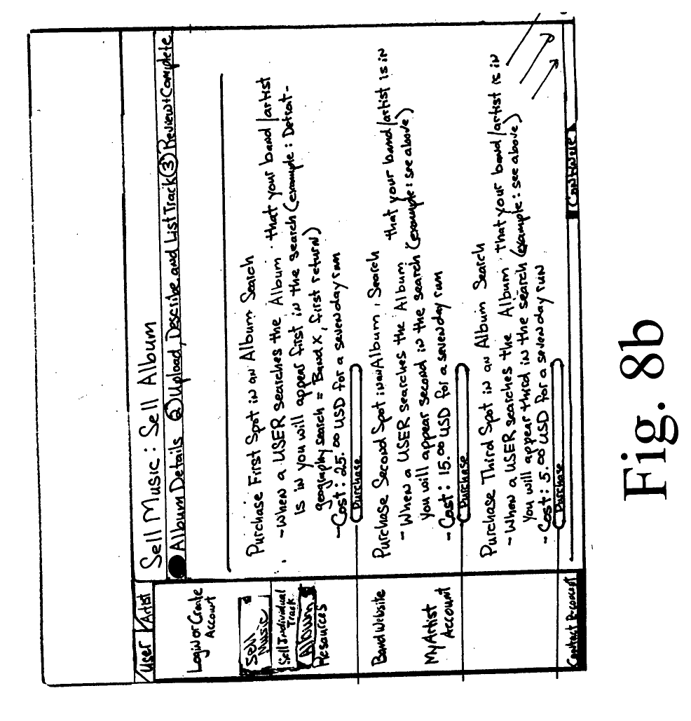

Now referring to FIGS. 7 an artist's resources are illustrated. An artist or band can search for professional instruction 43, professional representation, concert venues, gigs, new band members, and recording studios by country 44 or region 45. Artists can also search for projects/commissions, recording software, songwriters, music information websites, recording studios with artist and studio feedback and a rating system for both artists and studios, in addition to other resources such as classified and weblinks. In addition to searching, artists can also list their own posts or classified for the above topics.

In yet another embodiment, the system of the present invention can be applied beyond the music industry. General media content, such as motion picture film, film shorts, animation, cartoons, flash animation as well as still picture art and other still visual art could all benefit from the same platform. Although the entertainment industry does not play as great a pre-selecting role as the music industry does, there is still some form of a larger pool of media from which certain general media content is pulled for presentation to the general public. Offering a marketplace platform where the creators of the general media content could offer it with the same ease as the consumer could browse to find what he/she wanted might be beneficial to both parties. This would also reduce the risk for the entertainment industry by providing the same predictive tool that the platform would offer the music industry as pre-selector.

With general media content, there is still a relatively high cost of production (although it has greatly declined from years past and is, according to some figures, still declining). This alone does not preclude the success of the marketplace platform by presenting a lack of media that could be posted for the consumer on the market. There is a tremendous amount of general media content produced that may never be intended for the industry/authority selection process but is produced for a variety of other reasons such as those films produced for film festivals, student films and flash artwork produced for a variety of reason; film shorts produced as demos.

There are some distinct changes that must be made to the system of the present invention before applying the marketplace platform to general media content. First, it would require more space to house larger files. Second, prices would be higher since the cost of production would be higher. Third, a detailed description of the file and perhaps a sample of the file would have to be provided because of its size and cost. Fourth, segmentation of the market place would have to be more intricate because there would be numerous media types, such as film/motion picture or flash, and within each of those there would be different segmentations such as genre or length (length—film e.g. short, feature length, multipart). Each of these media types might have a different segmentation and would therefore require a more detailed design for the application that would provide the marketplace platform. Finally, some form of content regulation in the form of a rating system would have to be provided but might be accomplished by detailed parental controls.

Possible uses and benefits from the marketplace platform might also vary. The market platform of the present invention could be used as a secondary marketplace for all general media content that the industry had not selected. It could be used as a place for general media content makers/producers to post their content for purposes of advertisement or as a calling card.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for the process of music creation, development, and distribution comprising:
a central server system and database on which to store and serve the uploaded music files;
a central transaction processing system and database;
a software application to effectuate communicate with the central server system and the central transaction processing system and database over a wide area network;
music content contained a central server database
wherein said central transaction processing system and database, stores and processes all data necessary to complete a transaction between an artist and a user;
wherein said central transaction processing system and database, a transaction between a user and artist, determines the adjustment to the accounts of the artists, the user and provider by determine the amount deducted from the user account, the amount added to the artist account and the amount added to the provider's account;
wherein said central transaction processing system and database maintains a running total of all the accounts;
said software application displays account information through the artist's sales dashboard and the user activity dashboard for those individuals reference; and
the central transaction processing system and database also handle transactions for gift-certificate purchases and for paying into a users account.

2. The method for the process of music creation, development, and distribution of claim 1 further comprising:
a resource directory; and
a central download statistical database that collects all information on each individual download including but not exclusive to:
a. users who downloaded;
b. user profiles;
c. artist status; and
d. transaction details such as the price paid for the download, the date and time of the transaction.

3. The method for the process of music creation, development, and distribution of claim 2 wherein central download statistical database incorporates a predictive tool wherein the recorded data yields patterns among user purchases of music and gives an accurate prediction of an artists success in general based on the amount of their music that is purchased and downloaded by users.

4. The method for the process of music creation, development, and distribution of claim 3 wherein said predictive tool also predicts success more specifically amongst certain user age groups or in certain geographic markets.

5. The method for the process of music creation, development, and distribution of claim 1 further comprising promotion features through a web dialogue between the application and the central server system wherein the central server system overlaps with the central transaction processing system and database such that when the purchase of an additional promotion is made it would be processed by the transaction processing database and then the actual promotion and its placement would be handled by the central server system.

6. The method for the process of music creation, development, and distribution of claim 1 further comprising the following purchase sequence:
a user selects a track, album or group of tracks or albums from a search menu display of searched tracks or albums that were returned from a user initiated search;
the user clicks on the purchase button that is associated with the desired track, album or group of tracks or albums;
if the user has inputted a Credit Card into an account or has paid a balance forward then the purchase pop-up window appears; if the user purchases, then the purchase is logged in the central transaction processing system and database and the transaction record is logged in the central download statistical database; or
if the user does not have a Credit Card inputted into account, the user must enter Credit Card information to confirm and make the purchase,
if the user is purchasing a single track, the user must have paid a balance forward;
the transaction is logged into the central transaction processing system and database and the provider fee is calculated and deducted, the present artist balance is adjusted, the date and time of sale logged, the track/album logged, the price paid logged, the fee logged, the net amount logged and the user who purchased logged is then sent to the artist sales dashboard for display under a music management function and the information is sent to the user activity dashboard under the headings of date/time purchased, track/album title, price, artist purchased from; and
all transaction details are logged into the central download statistical database.

7. The method for the process of music creation, development, and distribution of claim 7 where said user select a track, album or group of tracks or albums via:
a click thru from one of the avenues available on a user Front Page such as:
a. the listing of the newly released independent artists,
b. the listing of major music label represented artists music that has just been released,
c. the listing of the daily top ten most downloaded songs, or
d. the provider staff picks; or
featured artist bubble click thru as displayed by the software application.

8. The method for the process of music creation, development, and distribution of claim 1 further comprising a user front page comprising:
navigation for the software application;
purchased promotional displays by an artist;
an non-promotional displays that is they do not require purchase by the artists but are rather driven by other factors;
and a separate display of new music from major listing artists, musicians, and labels as well as several selected bands from as selected by the application software;
a display of the day's top downloads.

9. The method for the process of music creation, development, and distribution of claim 1 further comprising a search function by which the user can find music from listing artists, musicians, and labs.

10. The method for the process of music creation, development, and distribution of claim 9 wherein
the search results are displayed in a grid below the search field, which remains for the reference of the user;
the entire result is placed under a “tab” that allows the user to engage in multiple searches and move between each of these searches with ease similar to the way a user might click between windows on a desktop;
the search results are displayed in a grid and segmented into categories—Song Title, Artist, Album, Time, Relevance, File Type, Price and all have a purchase button attached to them;
the categories can be sorted individually and allow user to sort Song Title, Artist, Album in alphabetical or reverse alphabetical order and allows user to sort Time, Relevance and Price categories in ascending or descending order; and
a Purchase Button remains attached to each individual song/track entry.

11. The method for the process of music creation, development, and distribution of claim 10 wherein
if listing artists, musicians, or labels opt for the R-concept promotional device of album promotion in the search results then when user searches for a Song, Artist, or Album in the search an album will appear in a display at the top of the search result display within the tab for that particular search;
the album display will consist of a small thumbnail piece of artwork that the Independent artist or major music labeled represented artist will provide when designing their promotional options and allow the user to immediately view and then purchase the album displayed;
if the user search yields multiple different Independent artists and/or Major music label represented artists and their Song Titles and Albums, all of whom have some bearing to the search then the one with the highest relevance will have their Album Promotion displayed.

12. The method for the process of music creation, development, and distribution of claim 1 further comprising a user library function by which the user stores and categorizes purchased music further comprising a library display that is reflective of a file folder on the user's computer where the actual music files are stored.

13. The method for the process of music creation, development, and distribution of claim 12 further comprising a library function which displays each of these files along with information on their individual characteristics.

14. The method for the process of music creation, development, and distribution of claim 13 further comprising a user rating function within the user library function and the user search function wherein after downloading a music file the user can rate the music file through the rating function within the user library.

15. The method for the process of music creation, development, and distribution of claim 14 wherein the user rating function dialogues with the central server sending the user's rating in the Library to the central server which then compiles this data into an aggregate from every user that rated that particular file, yielding an Average user Rating that is then attached to the music file for all other users to see when it is presented in the Search Page.

16. The method for the process of music creation, development, and distribution of claim 1 wherein the user procedure for signup and music purchase comprises the following steps:
a user goes to a website to download the software application;
user downloads said software application and installs it on their computer;
user completes a registration process;
user selects a track or album or group of tracks or albums;
user clicks on the purchase button that is attached to every track or album or group of tracks or albums;
user completes a purchase sequence; and
the transaction record is logged in the Central Download Statistical Database.

17. The method for the process of music creation, development, and distribution of claim 1 wherein an artist, musician, or label may purchase one or more of the promotional devices.

18. The method for the process of music creation, development, and distribution of claim 17 wherein the artist procedure for signup and music distribution comprises the following steps:
an artists goes to a website to download the software application;
the artist downloads the software application and installs it on his/her computer;
the artist goes through the user registration process
the artist goes to an artist front page.
the artists creates an account and all information is stored on the central transaction processing system and database and the central download statistical database for account creation and processing of transactions;
the artist distributes music by offering it for sale through a sell music wizard;
the artist chooses to sell an album or individual tracks and enters the requested information and uploads the music files to the central server;
if music that the artist uploads is purchased by a user, then the monies the user pays are deposited into a central account and logged into an artist's dashboard display which allows for balance review and withdrawals.

19. The method for the process of music creation, development, and distribution of claim 18 further comprising a sell music function comprised of a variety of different promotion options:
a featured artist bubble is a stationary website billboard whose contents are always rotating;
an artist may purchase a priority in the search result for any particular search term or category;
album promotion consists of a small thumbnail picture of artwork that is provided by the Artist or selected form a group of clipart. It is positioned in the user search page function just above the search result;

20. The method for the process of music creation, development, and distribution of claim 1 wherein said sales dashboard allows artist to monitor all transaction made that involve the purchase of the music they have listed which is displayed in a grid and consists of:
the date and time sold;
the track or album title;
the price;
the sales fee;
the net amount received; and
and the username of the purchaser.
